(19) United States
(12) Patent Application Publication
(10) Pub. No.: US 2013/0063341 A1
(43) Pub. Date: Mar. 14, 2013

(54) DISPLAY DEVICE ADJUSTMENT SYSTEM, AND ADJUSTMENT METHOD

(71) Applicant: Kenji HIRATA, Osaka (JP)

(72) Inventor: Kenji HIRATA, Osaka (JP)

(73) Assignee: Panasonic Corporation, Osaka (JP)

(21) Appl. No.: 13/607,805

(22) Filed: Sep. 10, 2012

(30) Foreign Application Priority Data
Sep. 14, 2011 (JP) 2011-200472
Jul. 23, 2012 (JP) 2012-162423

(51) Int. Cl. G09G 5/00; G06F 3/01

(52) U.S. Cl. 345/156; 345/2.1

(57) ABSTRACT

A system controller comprises a normal mode and a maintenance mode as its control modes, and switches the mode so that electronic control buttons are assigned the functions of calling a crew member, onboard communications, switching seat lighting on or off at each seat, etc., in normal mode, and the picture quality and brightness of a large monitor are adjusted in maintenance mode.

### BACKGROUND OF THE INVENTION

1. Technical Field

This disclosure relates to a system that includes a plurality of display devices, and more particularly relates to an adjustment method and a system for adjusting a plurality of display devices.

2. Description of the Related Art

In the past, the picture quality and brightness of a liquid crystal display or other such display device had to be adjusted whenever there were changes over time or to suit the surrounding environment.

In adjusting the picture quality and brightness of a display device, control buttons, control levers, touch panels, a remote control, or the like provided to each display device is generally used to perform the adjustment while the user looks at the display screens thereof.

For example, aircraft and other such moving bodies are equipped at each seat with devices that passengers can operate, such as handsets that allow onboard communication or the like, or individual monitors featuring touch panels that allow the passengers to watch and listen and perform input operations. The picture quality and brightness of these individual monitors are adjusted by using a touch panel, handset, or the like.

Also, on an aircraft, if individual monitors are not installed at each seat, a large monitor may be provided for each group of a plurality of seats so that the content of a movie or the like can be enjoyed on the large screen. A large monitor such as this is installed on the ceiling so that a single screen will be visible to a number of people, and control buttons, remote controls, or the like are generally not provided for each large monitor so that ordinary passengers cannot operate the monitor at will.

Accordingly, adjustment of the picture quality and brightness of these large monitors was carried out all at once for a plurality of large monitors, using an onboard control system, by the maintenance crew when there were no passengers on board.

In this case, however, the location where the adjustment work is performed is usually remote from the large monitors, making it impossible to make the adjustments and look at the display screens at the same time. Therefore, either the crew had to take the time to repeat adjustment and checking, or they could only make rough adjustments.

Ways to solve this problem include a method in which a dedicated adjustment remote control is readied for each large monitor, and a method in which an existing system is utilized to make the adjustments.

For instance, Japanese Laid-Open Patent Application 2002-236464 discloses a technique in which, with a large-screen video adjustment device with which video displayed on a large-screen video device is watched from a specific distance and the display state is adjusted on the basis of the watching result, adjustment data is transmitted to the large-screen video device side using a portable telephone through a public line, whereby the brightness, hue, and so forth are adjusted while the adjuster looks at the display screen of the large video device.

FIG. 8 is a block diagram of the configuration of a display adjustment control system used to adjust the display of a large-screen video display device, as disclosed in Japanese Laid-Open Patent Application 2002-236464.

In FIG. 8, when the keys on a ten-key pad of a portable telephone 25 are operated, a corresponding telephone signal is sent to a telephone exchange 27. The telephone signal that is sent goes through the telephone exchange 27 and a public telephone network line to a telephone signal receiving device 26.

When the keys on the portable telephone 25 are operated, the telephone signal receiving device 26 indicates on a display controller 22 of a large-screen video display device 24 the selection of video adjustment, unit adjustment, and brightness adjustment for the entire screen, whether or not there is a screen display, and on/off switching of the power to the keypad. The display controller 22 performs adjustment by controlling a plurality of units 100 of a large-screen video display 21 via a signal router 23.

Thus, with the adjustment system of the above-mentioned Japanese Laid-Open Patent Application 2002-236464, the video display state of a video display can be adjusted by utilizing an existing portable telephone and public telephone network line, which makes the work more efficient.

### SUMMARY

However, readying dedicated picture quality and brightness adjustment remote controls for each large monitor just for maintenance, as with the above-mentioned conventional adjustment system, is not practical. Another problem is that various display devices or a system including these display devices must be provided in advance with an infrared receiver, a wireless receiver, or another such receiver.

Also, with the picture quality and brightness adjustment method of the above-mentioned Japanese Laid-Open Patent Application 2002-236464, there is no need for a dedicated adjustment remote control, but a problem is that when adjustment is performed, a communication line must be established between the portable telephone or other such adjustment device being used and a telephone signal receiving device.

Also, with the above-mentioned Japanese Laid-Open Patent Application 2002-236464, an existing system can be utilized, but there is a new requirement of a telephone signal receiving device for receiving telephone signals and giving instructions to the display controller.

It is an object of this disclosure to provide a display device adjustment system and an adjustment method with which there is no need for a remote control or other such dedicated adjustment device or dedicated control signal receiver for a plurality of display devices, and the picture quality and brightness of a display device can be adjusted while looking an individual display screens, without having to add any separate telephone signal receiving device or other such external device.

To achieve the stated object, the display device adjustment system of this disclosure comprises a first display device, a plurality of second display devices, a plurality of terminal devices, and a control device. The plurality of terminal devices are provided corresponding respectively to the plurality of second display devices, and are used to operate the second display devices. The control device controls the first display device, the plurality of second display devices, and the plurality of terminal devices, has a normal mode used for the normal operation of the second display devices and a maintenance mode that allows various kinds of adjustment of the first display device, and switches from the normal mode to the maintenance mode when the maintenance mode is selected in order to perform maintenance on the first display device.

The above-mentioned “normal mode” here means a control mode for performing operations such as tuning and volume adjustment, menu selection, switching lights on or off, emitting call sounds, and so forth on the basis of user operation. Also, the above-mentioned “maintenance mode” means a control mode for adjusting the picture quality and brightness of the first display device, for example.

The above-mentioned “first display device” includes a large monitor installed inside an aircraft or other such moving body, in a theater room, or the like. The above-mentioned “second display device” includes a seat monitor installed inside an aircraft or other such moving body, for example.

Here, the control device switches the function of the plurality of terminal devices from normal mode to maintenance mode when maintenance mode is selected.

Consequently, the picture quality and brightness of the first display device can be adjusted by using a corresponding terminal device provided in advance at a location where the first display device can be seen, for example, merely by switching the control mode of the control device.

Specifically, with this display device adjustment system, the picture quality, brightness, and so forth of the first display device can be adjusted when maintenance mode is selected by using the buttons on a controller that is provided ahead of time for each second display device and is used for tuning, volume adjustment, and the like in normal mode, for example.

In the above-mentioned maintenance mode, the picture quality, brightness, and so forth of the first display device can be adjusted with a particular terminal device, but the configuration of the terminal device may also be such that the picture quality, brightness, and so forth of a first display device within the viewable range can be adjusted. In this case, the first display device that is to be adjusted may be defined separately during the system setup.

Also, it is typically preferable if the terminal device used to adjust picture quality, brightness, and so forth when maintenance mode has been selected is disposed near the first display device to be operated, so that adjustment will be possible while viewing the display. The terminal device may also be one that has control buttons, a touch panel, or another such interface, and with which picture quality and brightness are adjusted by using this interface.

The display device adjustment system of this disclosure comprises a first display device, a plurality of electronic control components, and a control device. The plurality of electronic control components are respectively provided in the vicinity of a plurality of seats, and are used to operate devices around the seats. The control device controls the first display device and the devices around the seats, and the operating functions of the electronic control components include a normal mode used for the normal operation of the devices around the seats and a maintenance mode that allows various kinds of adjustment of the first display device. When the maintenance mode is selected in order to perform maintenance on the first display device, the control device switches from the normal mode to the maintenance mode.

The above-mentioned “normal mode” means a control mode for performing operations such as tuning and volume adjustment, menu selection, switching lights on or off, emitting call sounds, and so forth on the basis of user operation. Also, the above-mentioned “maintenance mode” means a control mode for adjusting the picture quality and brightness of the first display device, for example, by operating the electronic control components.

The above-mentioned “first display device” includes a large monitor installed inside an aircraft or other such moving body, in a theater room, or the like.

The control device here switches the function of the plurality of electronic control components from normal mode to maintenance mode when maintenance mode has been selected.

Consequently, the picture quality and brightness of the first display device can be adjusted by using a corresponding electronic control component provided in advance at a location where the first display device can be seen, for example, merely by switching the control mode of the control device.

### Effects

With the display device adjustment system of this disclosure, even with a first display device having no direct user interface such as control buttons or a remote control, the picture quality, brightness, and so forth of the first display device can be individually adjusted merely by switching the mode of the previously provided terminal device.

Also, because existing circuitry is utilized for the first and second display devices, the terminal devices, and the system control devices, there is no need to provide dedicated receivers or the like, and this reduces the cost.

In addition, there is no need for a dedicated terminal for adjustment, and separate management during adjustment is not necessary.

### BRIEF DESCRIPTION OF DRAWINGS

FIG. 1 is a simplified diagram of the configuration of the display device adjustment system pertaining to an embodiment of this disclosure;

FIG. 2 is a control block diagram of the display device adjustment system in FIG. 1;

FIG. 3 is a diagram of function blocks formed in the system controller in FIG. 2;

FIG. 4 is a flowchart of the procedure for adjusting the display device in FIG. 1;

FIG. 5 is a simplified diagram of the configuration of the display device adjustment system pertaining to another embodiment of this disclosure;

FIG. 6 is a control block diagram of the display device adjustment system in FIG. 5;

FIG. 7 is a simplified diagram of the configuration of the display device adjustment system pertaining to yet another embodiment of this disclosure;

FIG. 8 is a control block diagram of the display device adjustment system in FIG. 7; and

FIG. 9 is a block diagram of the configuration of a conventional display adjustment control system.

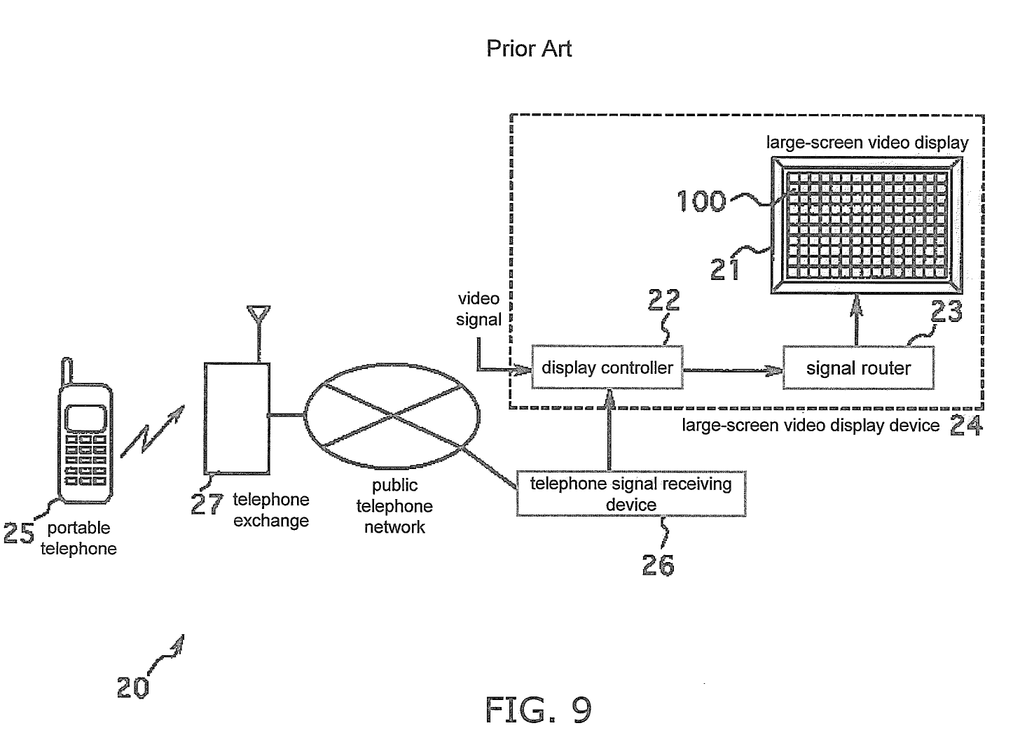

### DETAILED DESCRIPTION

Embodiments will now be described in detail through reference to the drawings as needed. However, these embodiments will not be described in more detail than necessary. For example, detailed descriptions of things that are already well known, or redundant descriptions of components that are substantially the same may, be omitted. The reason for this is to avoid making the following descriptions more complicated than necessary, and to facilitate an understanding on the part of a person skilled in the art. It will be apparent to those skilled in the art from this disclosure that the following descriptions of the embodiments are provided for illustration only and not for the purpose of limiting the invention as defined by the appended claims and their equivalents.

The applicant is providing the appended drawings and the following descriptions so that a person skilled in the art will be able to fully understand this disclosure, and does not intend to limit the subjects discussed in the patent claims by these descriptions.

### Embodiment 1

An embodiment of this disclosure will now be described through reference to the drawings.

### Configuration of System for Adjusting Picture Quality and Brightness of Display Device

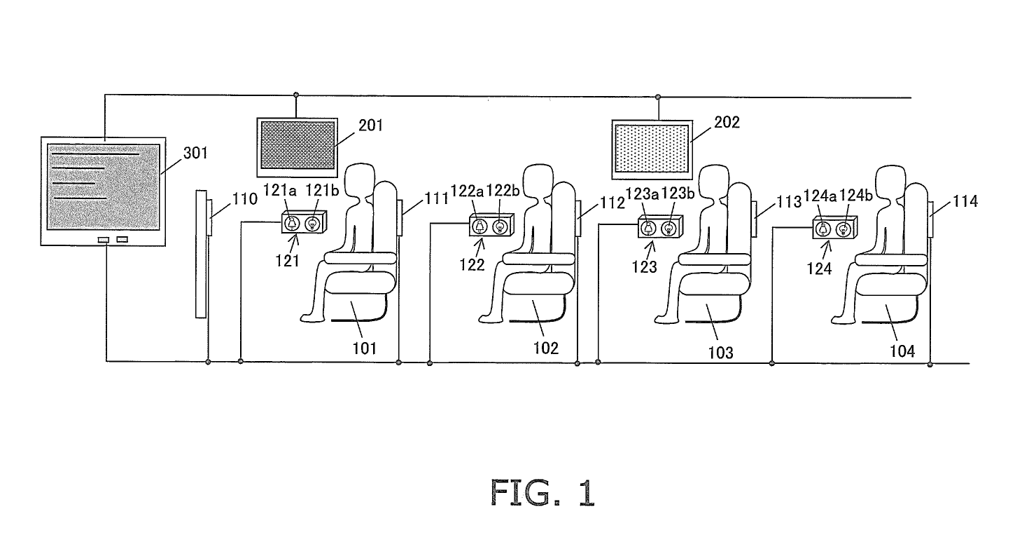

FIG. 1 is a simplified diagram of the configuration of the system for adjusting the picture quality and brightness of a display device pertaining to this embodiment. This shows an example of the layout of a system controller 301, seats 101 to 104, large monitors 201 and 202, seat monitors 110 to 114, and electronic control buttons (user interfaces for passengers) 121 to 124 in an aircraft.

Many seats and display devices are disposed in the aircraft, but for the sake of convenience in the description, only some of these are shown in FIG. 1.

As shown in FIG. 1, a plurality of seats 101 to 104 are disposed inside an aircraft. The large monitors (first display devices) 201 and 202 are also disposed at locations within the aircraft that are visible from a plurality of seats. The seat monitors (second display devices) 110 to 114 are further installed on the rear faces of the seat backs of the seats 101 to 104.

The seat monitors 110 to 114 are provided so that passengers can watch video content distributed from a server (not shown) in the aircraft. The seat monitors 110 to 114 can perform various kinds of input operation, such as the selection of video content from a touch panel provided to the front or from control buttons.

For example, a passenger sitting in seat 102 watches and operates the seat monitor 111 disposed on the rear face of the seat back of the seat 101 ahead.

Electronic control buttons (terminal devices, electronic control components) 121 to 124 for calling a cabin crew member, making an onboard call, switching the lights (spotlights) on or off at each seat, and so forth are installed at each of the plurality of seats 101 to 104.

As shown in FIG. 1, the electronic control buttons 121 to 124 typically have a cabin crew member call button 121a and a seat lighting on/off button 121b.

Also, the system controller (control device) 301 is disposed as a device for performing control of the system, including the large monitors 201 and 202, the seat monitors 110 to 114, and the electronic control buttons 121 to 124.

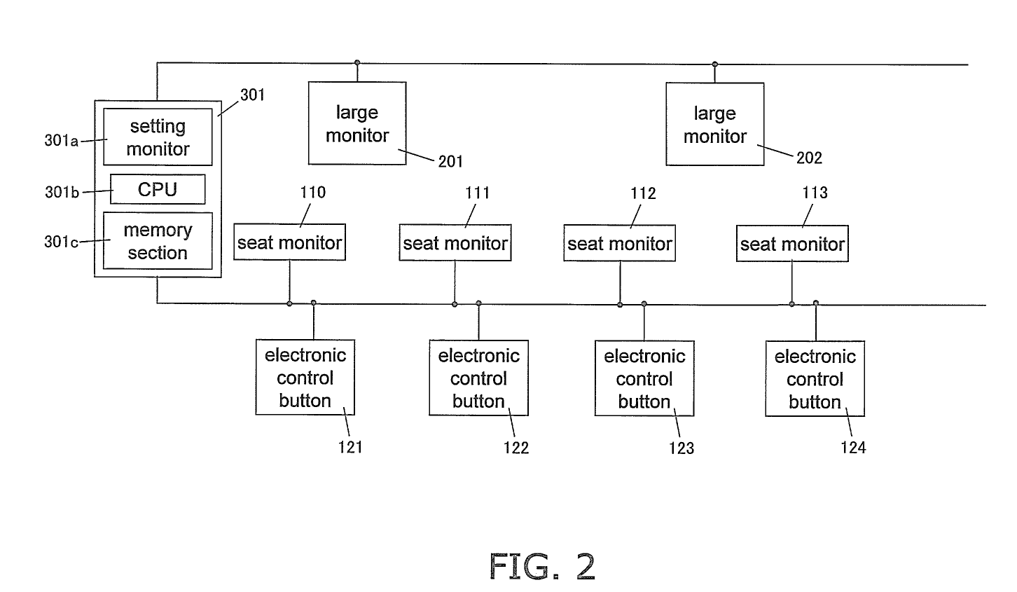

As shown in FIGS. 1 and 2, the system controller 301 is connected to the large monitors 201 and 202, the seat monitors 110 to 114, and the electronic control buttons 121 to 124. The system controller 301 switches the operation by the electronic control buttons 121 to 124 between normal operations, such as calling a cabin crew member, switching the seat lighting on or off, and so forth, and maintenance operations involving adjustment of the picture quality and brightness of the large monitors 201 and 202, according to settings made by a maintenance worker.

Specifically, the system controller 301 can perform different control for the entire system or just part of the system, which is accomplished when the control mode is selected by a maintenance worker.

More specifically, the system controller 301 has a normal mode for using the electronic control buttons 121 to 124 to perform normal operations, such as calling a cabin crew member or switching the seat lighting on or off, and a maintenance mode for performing various adjustments to the large monitors 201 and 202.

For example, if the normal mode has been selected in the system controller 301, the various buttons of the electronic control buttons 121 to 124 are assigned the above-mentioned functions of calling a cabin crew member, making an onboard call, switching the seat lights on and off, and so forth. On the other hand, when the maintenance mode has been selected, functions are assigned for adjusting the picture quality, brightness, and so forth of the large monitors 201 and 202.

When a maintenance worker or someone else selects the maintenance mode via a setting screen or the like of the system controller 301 in order to perform maintenance on the large monitors 201 and 202, the normal mode is switched to the maintenance mode.

In this embodiment, these devices are configured as a single system in which they are wired together, but the various devices may instead be connected wirelessly, and the form does not matter as long as the system is integrated.

Control Blocks of System Controller 301

As shown in FIG. 2, the system controller 301 has a setting monitor 301a, a CPU 301b, and a memory section 301c.

The setting monitor 301a is, for example, a touch panel type of operation monitor that is operated by a maintenance worker, and is used to make various settings on the seat monitors 110 to 113 and the large monitors 201 and 202, and make settings for mode setting (discussed below).

The CPU 301b carries out mode switching (discussed below) along with controlling the seat monitors 110 to 113 and the large monitors 201 and 202 on the basis of various programs or various kinds of information stored in the memory section 301c.

The memory section 301c holds a database of information related to the above-mentioned electronic control buttons 121 to 124 and the large monitors 201 and 202 to be adjusted, or the functions of the various buttons included in the electronic control buttons 121 to 124, various kinds of software, and so on.

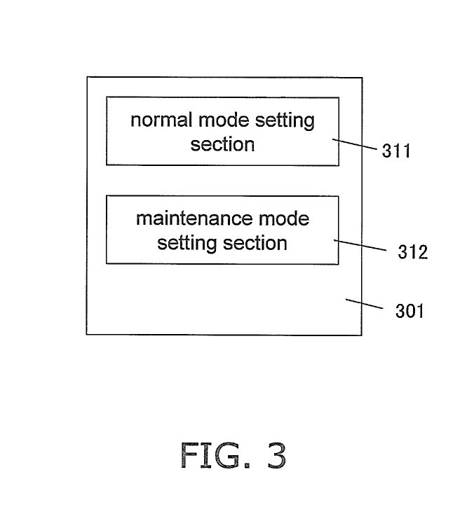

The system controller 301 reads the various programs stored in the memory section 301c shown in FIG. 2, and produces function blocks, namely, a normal mode setting section 311 and a maintenance mode setting section 312, internally as shown in FIG. 3.

When the normal mode has been selected, the normal mode setting section 311 goes through the setting monitor 301 a to set the functions of the cabin crew member call button 121 a and the seat lighting on/off button 121b included in the electronic control buttons 121 to 124 to be their original functions, namely, calling cabin crew members or switching seat lights on or off.

When the normal mode has been selected, the maintenance mode setting section 312 goes through the setting monitor 301a to switch the functions of the cabin crew member call button 121a and the seat lighting on/off button 121b included in the electronic control buttons 121 to 124 to functions used for maintenance mode.

Specifically, when the maintenance mode has been selected, for example, brightness adjustment of the large monitors 201 and 202 can be performed so that the cabin crew member call button 121a reduces brightness and the seat lighting on/off button 121b increases brightness.

When the cabin crew member call button 121a and the seat lighting on/off button 121b are both pressed at the same time, the functions of the cabin crew member call button 121a and the seat lighting on/off button 121b are switched from being control buttons used for brightness adjustment into those used for picture quality adjustment.

Consequently, the brightness adjustment and picture quality adjustment of the large monitor 201 or 202 can be performed merely by operating two buttons, namely, the cabin crew member call button 121a and the seat lighting on/off button 121b.

Method for Adjusting Large Monitors 201 and 202

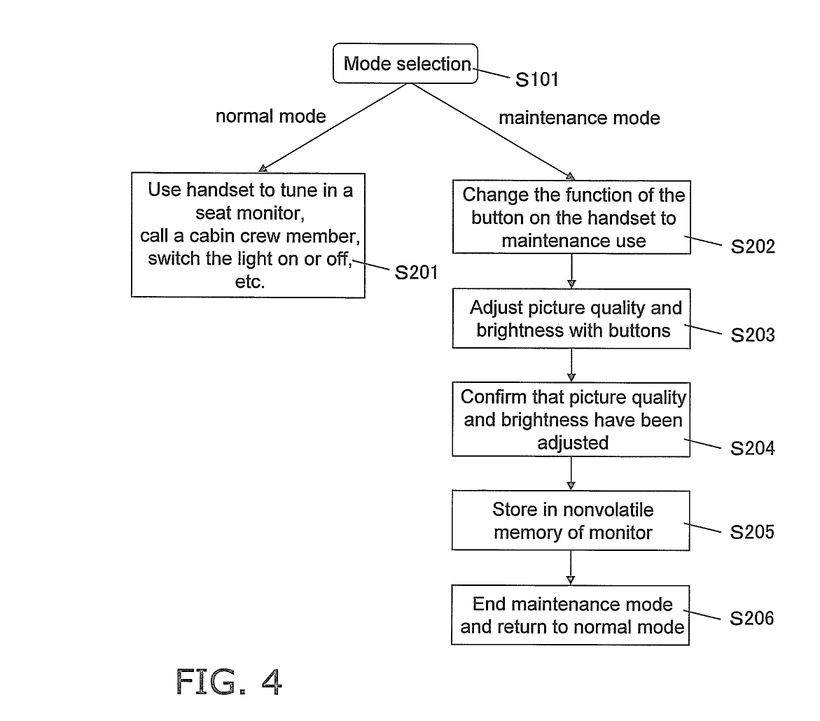

The procedure for adjusting the picture quality and brightness of the large monitors 201 and 202 with a system configured as above will be described through reference to the flowchart in FIG. 4.

First, in a state in which the normal mode has been selected during mode selection (S101), the functions of the electronic control buttons 121 to 124, such as calling a cabin crew member or switching the lights on or off, are activated by the normal mode setting section 311 (S201).

Meanwhile, when the picture quality, brightness, and so forth of the large monitors 201 and 202 are adjusted, the maintenance mode is selected in the system controller 301 by a maintenance worker or the like during mode selection (S101).

When the maintenance mode is selected in the system controller 301, the control mode is switched from normal mode to maintenance mode for all or part of the system.

Then, upon switching to maintenance mode, the maintenance mode setting section 312 changes the electronic control buttons 121 to 124 from normal mode to maintenance mode, in which they function as devices for adjusting picture quality and brightness.

More specifically, in adjusting the picture quality, brightness, and so forth of the large monitor 201, for example, the function of the electronic control buttons 121 at the seat 101, which is closest to the large monitor 201 and from which the screen of the large monitor 201 can be viewed straight ahead, is switched to a function of adjusting the picture quality and brightness of the large monitor 201 (S202).

Then, the maintenance worker uses the electronic control buttons 121 (the cabin crew member call button 121a and the seat lighting on/off button 121b) to adjust the picture quality, brightness, and so forth of the large monitor 201 while looking at the screen of the large monitor 201 (S203).

For example, the worker operates the cabin crew member call button after changing to maintenance mode, and thereby selects picture quality adjustment mode from among the picture quality and brightness adjustment modes while checking the display on the screen of the large monitor 201, after which the cabin crew member call button 121a and the seat lighting on/off button 121b are both used to adjust the contrast and so on of picture quality.

Similarly, the cabin crew member call button 121a and the seat lighting on/off button 121b are used to adjust the screen brightness after selecting the brightness adjustment mode, by pressing the two buttons at the same time.

The roles of these buttons may be provided as a database in the system ahead of time, or may be set through a removable external recording medium.

Similarly, the picture quality and brightness of the large monitor 202 can be adjusted by using the electronic control button 123 of the closest seat 103, which is closest to the large monitor 202 and from which the screen thereof can be viewed.

For the other large monitors not depicted in the drawings, the picture quality and brightness are adjusted by using the electronic control buttons 121 to 124 of the seats disposed close to each of the large monitors, in order.

Next, the worker checks whether or not the picture quality and brightness have been properly adjusted (S204).

Then, for example, the picture quality and brightness adjustment values that have been temporarily set can be automatically stored in a nonvolatile memory inside the large monitors 201 and 202 being adjusted (S205), so that the monitors are set to the adjusted picture quality and brightness the next time they are turned on.

As a general rule, the functions when maintenance mode has been selected can not be inferred from the display on the buttons of the electronic control buttons 121 to 124, and are just functions discussed in the maintenance manual, etc.

That is, the picture quality and brightness adjustment are carried out by a maintenance worker while no ordinary passengers are on board, so there is no need for ordinary passengers to know about the maintenance mode.

Upon completion of picture quality and brightness adjustment maintenance, the maintenance worker returns the control mode from maintenance mode back to normal mode in the system controller 301. Consequently, maintenance mode is quickly eliminated, and the buttons of the electronic control buttons 121 to 124 are returned to a state of having their normal mode functions (S206).

With this system, as discussed above, the control mode is changed merely by utilizing the system normally provided to an aircraft, and the adjustment of the picture quality, brightness, and so forth of a plurality of display devices can be performed while the maintenance worker looks at a screen.

In particular, when the large monitors 201 and 202 are liquid crystal monitors, because a characteristic of a liquid crystal monitor is a narrow field of vision, to accurately adjust the picture quality and brightness, the adjustment is preferably carried out from a position as close as possible to and directly in front of the large monitors 201 and 202.

Thus, with the adjustment system of this embodiment, when the large monitor 201 is being adjusted, if the electronic control buttons 121 provided to the seat 101 disposed close to and directly in front of the large monitor 201, then the picture quality and brightness of the large monitor 201 can be adjusted more accurately.

### Embodiment 2

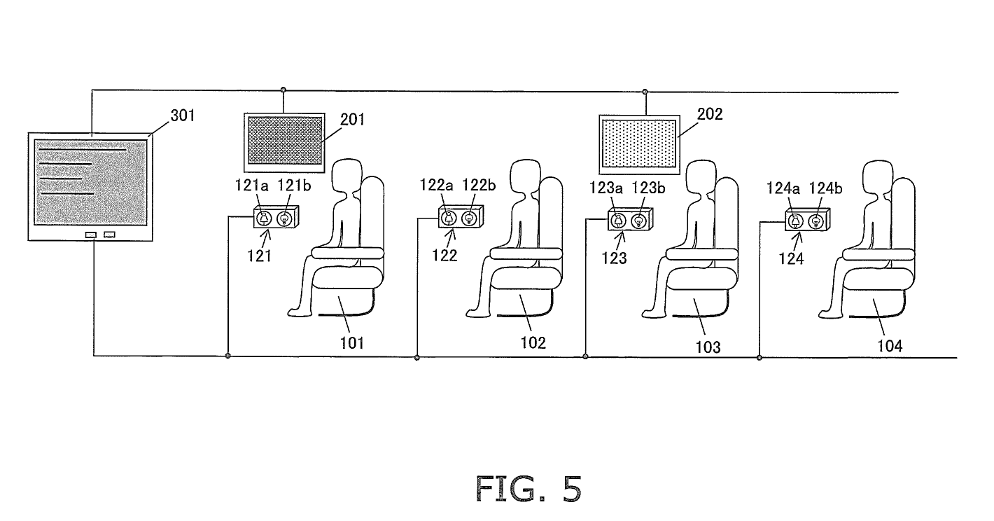

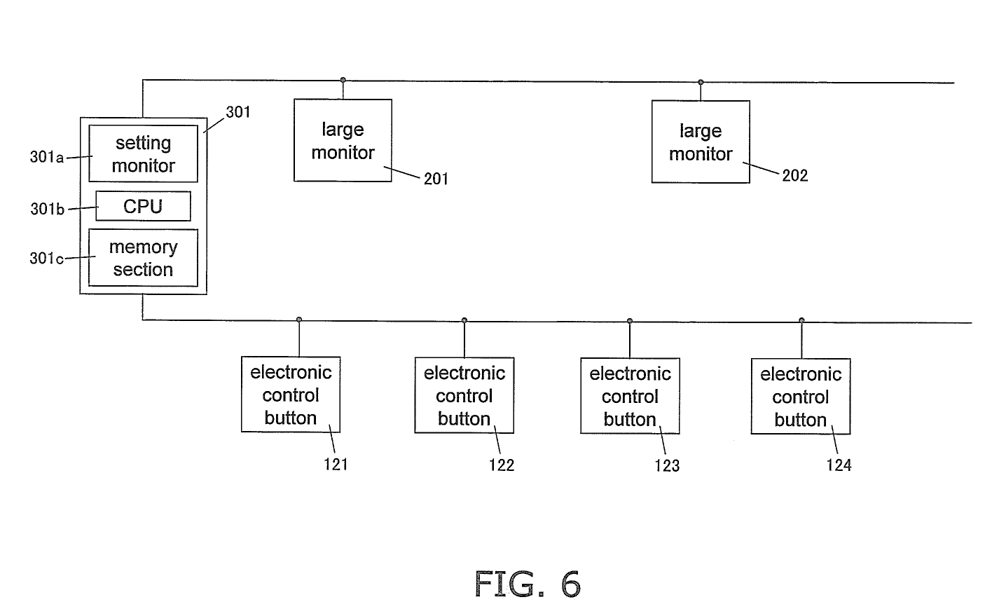

The display device adjustment system and adjustment method pertaining to another embodiment of the present disclosure will now be described through reference to FIGS. 5 and 6.

The display device adjustment system of this embodiment differs from that of Embodiment 1 above in that the seat monitors 111 to 114 corresponding to the seats 101 to 104 in an aircraft are not provided. The rest of the configuration is basically the same as that in Embodiment 1 above.

FIG. 5 is a simplified diagram of the configuration of the system for adjusting the picture quality and brightness of a display device pertaining to this embodiment, and just as in FIG. 1 of Embodiment 1 above, it shows an example of the layout of a system controller (control device) 301, seats 101 to 104, large monitors (first display devices) 201 and 202, and electronic control buttons (terminal devices; electronic control components) (user interfaces for passengers) 121 to 124 in an aircraft.

Also, just as in FIG. 1 of Embodiment 1 above, many seats and display devices are disposed in the aircraft, but for the sake of convenience in the description, only some of these are shown in FIG. 5.

As shown in FIGS. 5 and 6, with the adjustment system in this embodiment, the electronic control buttons 121 to 124 are respectively provided to the seats 101 to 104, a plurality of which are disposed in the aircraft.

Just as in Embodiment 1 above, the electronic control buttons 121 to 124 have the cabin crew member call buttons 121a to 124a and the seat lighting on/off buttons 121b to 124b.

Also, with the adjustment system in this embodiment, just as in Embodiment 1 above, the cabin crew member call buttons 121a to 124a (for calling a cabin crew member) and the seat lighting on/off buttons 121b to 124b (for switching the seat lights on and off) are used in the adjustment of the picture quality and brightness of the large monitors 201 and 202.

The procedure for changing the control mode by using the system controller 301 is the same as that described in Embodiment 1 above through reference to FIG. 4.

Thus, as shown in FIG. 6, with the adjustment system of this embodiment, the same effect as that of Embodiment 1 above can be obtained with a simple system configuration that has no seat monitors corresponding to the plurality of seats 101 to 104 installed in the aircraft.

### Embodiment 3

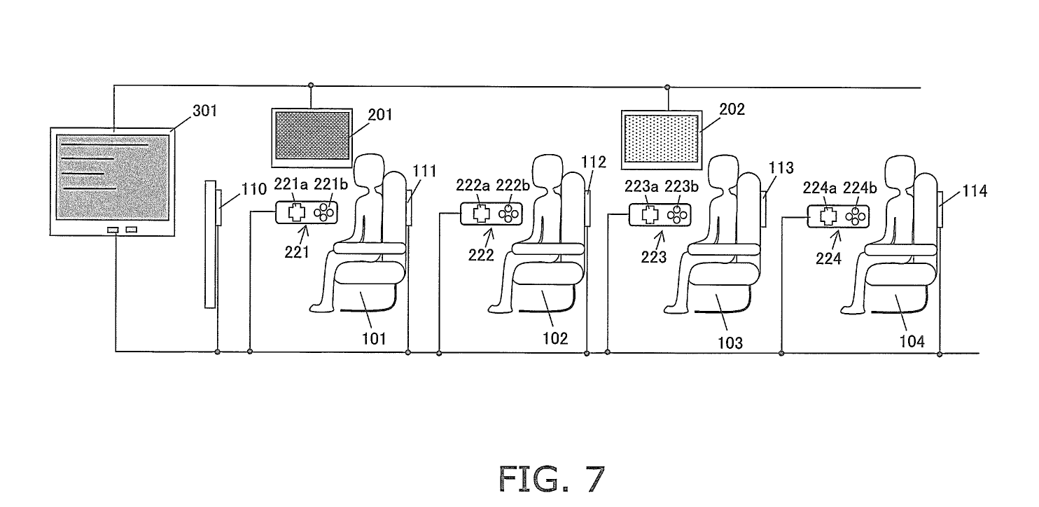

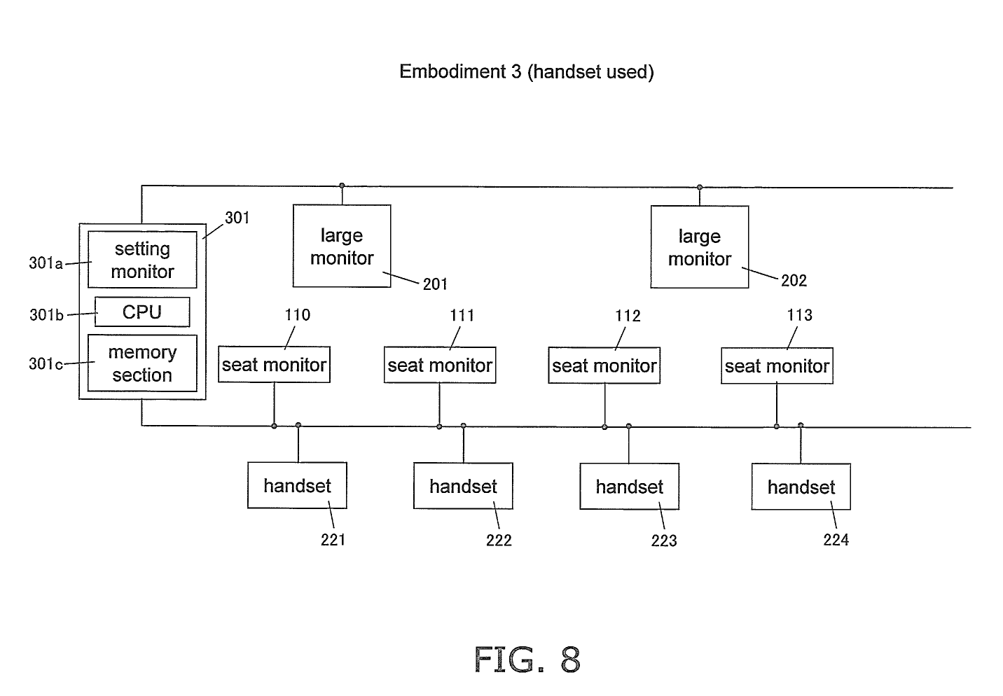

The display device adjustment system and adjustment method pertaining to yet another embodiment of the present disclosure will now be described through reference to FIGS. 7 and 8.

The display device adjustment system of this embodiment differs from that of Embodiments 1 and 2 above in that handsets 221 to 224 are used instead of the electronic control buttons 121 to 124 as the electronic control components (terminal devices) used to adjust the large monitors 201 and 202. The rest of the configuration is basically the same as that in Embodiment 1 above.

FIG. 7 is a simplified diagram of the configuration of the system for adjusting the picture quality and brightness of a display device pertaining to this embodiment, and it shows an example of the layout of a system controller (control device) 301, seats 101 to 104, large monitors (first display devices) 201 and 202, seat monitors (second display devices) 110 to 114, and handsets (terminal devices; electronic control components) (user interfaces for passengers) 221 to 224 in an aircraft.

Also, just as in FIG. 1 of Embodiment 1 above, etc., many seats and display devices are disposed in the aircraft, but for the sake of convenience in the description, only some of these are shown in FIG. 7.

As shown in FIGS. 7 and 8, with the adjustment system in this embodiment, the handsets 221 to 224 (which are operated by passengers) are provided to the seat monitors 110 to 113 disposed corresponding to the front faces of the plurality of seats 101 to 104 installed in the aircraft.

The handsets 221 to 224 have cross keys 221a to 224a and control buttons 221b to 224b for adjusting the volume of the seat monitors 110 to 114, switching the channel, and so forth. Although not depicted, the handsets 221 to 224 also comprise control buttons for operating the seat monitors 111 to 114, onboard communication microphones, and so on.

In this embodiment, as described in Embodiment 1 above, when the control mode is switched from normal mode to maintenance mode via the system controller 301, the functions of the cross keys 221a to 224a and the control buttons 221b to 224b are switched to functions for use in maintenance mode.

More specifically, for example, the cross keys 221a to 224a function as control buttons for picture quality adjustment, while the control buttons 221b to 224b function as control buttons for brightness adjustment.

The procedure for changing the control mode by using the system controller 301 is the same as that described in Embodiment 1 above through reference to FIG. 4.

Thus, with the adjustment system of this embodiment, the same effect as that of Embodiment 1 above can be obtained by adjusting the picture quality, brightness, and so forth of the large monitors 201 and 202 by using the cross keys 221a to 224a and the control buttons 221b to 224b to adjust the volume of the seat monitors 110 to 113, switch the channel, and so forth in normal mode.

### Other Embodiments

Embodiments of this disclosure were described above, but this disclosure is not limited to or by the above embodiments, and various modifications are possible without departing from the gist of the disclosure.

(A)

In Embodiment 1 above, an example was given in which the electronic control buttons 121 of the seat 101, which was closest to the large monitor 201 and from which its screen could be viewed, were used to adjust the large monitor 201, but this disclosure is not limited to this.

As long as the seat allows the screen of the large monitor 201 to be viewed, the electronic control button 122 of the seat 102 may be used to adjust the picture quality, brightness, and so forth of the large monitor 201.

(B)

In Embodiment 3 above, an example was given in which the functions of the various buttons of the handsets 221 to 224 in normal mode were to adjust the volume of the corresponding seat monitors 110 to 113, switch the channel, etc., and were to adjust the large monitors 201 and 202 in maintenance mode, but this disclosure is not limited to this.

For instance, if the handsets 221 to 224 are equipped with buttons for adjusting the picture quality, brightness, and so forth of the corresponding seat monitors 110 to 113, these buttons may be operated to switch the first display device to be adjusted between the large monitors 201 and 202 from the seat monitors 110 to 113, and then to adjust the picture quality and brightness of the large monitors 201 and 202.

This allows the display of the adjustment of picture quality, brightness, and so forth of the handsets 221 to 224 to be used just as it is, and to thereby adjust the picture quality and brightness of the large monitors 201 and 202.

(C)

In Embodiments 1 and 3 above, an example was given in which the electronic control buttons 121 to 124 or the handsets 221 to 224 were used to adjust the picture quality, brightness, and so forth of the large monitors 201 and 202, but this disclosure is not limited to this.

For instance, with a system that includes the seat monitors 110 to 113, the picture quality, brightness, and so forth of the large monitors 201 and 202, etc., may be adjusted by switching the function of the control buttons or touch panels provided to the seat monitors 110 to 113 from normal mode to maintenance mode with the system controller 301.

(D)

In Embodiments 1 and 3 above, an example was given in which the electronic control buttons 121 to 124 and the handsets 221 to 224 were used to adjust the picture quality, brightness, and so forth of the large monitors 201 and 202, but this disclosure is not limited to this.

For instance, the picture quality, brightness, and so forth of the large monitors 201 and 202 may be adjusted using electronic control components at positions that allow the large monitors 201 and 202 to be viewed, such as control buttons for reclining the seat backs.

(E)

The categories that were adjusted on the large monitors 201 and 202 in this disclosure may, of course, be something other than picture quality and brightness.

For instance, if speakers are built into the large monitors 201 and 202, their volume may be adjusted.

### INDUSTRIAL APPLICABILITY

With this disclosure, the picture quality and brightness of a plurality of display devices can be adjusted individually merely by changing the control mode, using an existing system and without having to add an separate telephone signal reception device or other such external device, and without needing a remote control or other such dedicated adjustment device, or any dedicated control signal receiver, and is therefore useful in devices and systems that control a plurality of grouped display devices provided not only to aircraft and other such moving bodies, but also to set spaces such as large halls or interior spaces.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions display device adjustment system, and adjustment method. Accordingly, these terms, as utilized to describe the technology disclosed herein should be interpreted relative to a display device adjustment system.

The term “configured” as used herein to describe a component, section, or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicants, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. A display device adjustment system, comprising:
a first display device;
a plurality of second display devices;
a plurality of terminal devices corresponding to the plurality of second display devices configured to operate the second display devices; and
a control device configured to control the first display device, the plurality of second display devices, and the plurality of terminal devices,
the terminal devices including a normal mode operation function for the normal operation of the second display devices, and a maintenance mode operation function that allows various kinds of adjustment of the first display device, and when the maintenance mode is selected in order to perform maintenance on the first display device, the control device switches from the normal mode to the maintenance mode.

2. The display device adjustment system according to claim 1,
wherein the adjustment of picture quality or brightness is included in the adjustment of the plurality of second display devices.

3. The display device adjustment system according to claim 1,
further comprising a database in which is recorded information related to the first display device and the corresponding plurality of terminal devices in the maintenance mode.

4. The display device adjustment system according to claim 1,
wherein the plurality of terminal devices can be operated while viewing the first display device that has been set to be adjusted.

5. The display device adjustment system according to claim 1,
wherein the first display device and the plurality of terminal devices are connected wirelessly.

6. The display device adjustment system according to claim 1,
wherein the plurality of terminal devices are handsets that are respectively provided to a plurality of seats installed in a moving body and operate the second display devices when normal mode has been selected.

7. The display device adjustment system according to claim 1,
wherein the plurality of terminal devices are electronic control buttons that are respectively provided to a plurality of seats installed in a moving body configured to call a crew member, perform communication within the moving body, switch the lighting on or off at each seat, etc., when normal mode has been selected.

8. The display device adjustment system according to claim 1,
wherein the plurality of terminal devices are seat monitors respectively provided to a plurality of seats installed in a moving body.

9. A method for adjusting a display device, comprising the steps of:
selectively switching between a normal mode used for the normal operation of a plurality of second display devices and a maintenance mode that allows various kinds of adjustment of a first display device that is different from the second display devices, as the control modes for a control device that controls the second display devices and a corresponding plurality of terminal devices;
switching the function of the plurality of terminal devices to maintenance use for making various kinds of adjustment to the first display device when the maintenance mode has been selected; and
adjusting the first display device to which the plurality of terminal devices respectively correspond.

10. A display device adjustment system, comprising:
a first display device;
a plurality of electronic control components that are respectively provided in the vicinity of a plurality of seats that operate devices around the seats; and
a control device that controls the first display device and the devices around the seats, the operating functions of the electronic control components include a normal mode used for the normal operation of the devices around the seats and a maintenance mode that allows various kinds of adjustment of the first display device, and when the maintenance mode is selected in order to perform maintenance on the first display device, the control device switches from the normal mode to the maintenance mode.
